(19) United States
(12) Patent Application Publication
(10) Pub. No.: US 2022/0050125 A1
(43) Pub. Date: Feb. 17, 2022

(54) PROBE PRODUCTION METHOD AND SURFACE OBSERVATION METHOD

(71) Applicant: SHOWA DENKO K.K., Tokyo (JP)

(72) Inventors: Tsuyoshi KATO, Ichihara-shi (JP); Hiroyuki TOMITA, Ichihara-shi (JP); Takuya MINAMI, Chiba-shi (JP); Shohei NISHIZAWA, Ichihara-shi (JP); Yoshitomo SHIMAZU, Chiba-shi (JP); Gohei KUROKAWA, Ichihara-shi (JP); Katsumi MUROFUSHI, Tokyo (JP); Naoya FUKUMOTO, Ichihara-shi (JP)

(73) Assignee: SHOWA DENKO K.K., Tokyo (JP)

(21) Appl. No.: 17/435,426

(22) PCT Filed: Mar. 3, 2020
(86) PCT No.: PCT/JP2020/008852

§ 371 Date: Sep. 1, 2021

(30) Foreign Application Priority Data
Mar. 5, 2019 (JP) 2019-039865

(51) Int. Cl. G01Q 60/42; G01Q 70/18; G01Q 80/00; G01Q 70/10; G01Q 70/14

(52) U.S. Cl. CPC G01Q 60/42; G01Q 70/18; G01Q 70/14; G01Q 70/10; G01Q 80/00

(57) ABSTRACT

This probe production method is a method of producing a probe (101) having a coating layer (104) on a surface thereof, in which the coating layer (104) is formed on a surface of a base material (103) having a sharp tip end portion (103a) using a gas phase method.

### TECHNICAL FIELD

The present invention relates to a method of producing a probe for detecting a tunnel current, an atomic force, and the like and further to a method of observing a surface of a sample using the probe. Priority is claimed on Japanese Patent Application No. 2019-039865, filed Mar. 5, 2019, the content of which is incorporated herein by reference.

### BACKGROUND ART

In recent years, as an observation method having high resolution in a real space regardless of whether a sample is a single crystal or amorphous, apparatuses for measuring various forces due to a proximity interaction between the sample and a probe electrode have been developed. These apparatuses are collectively referred to as scanning probe microscopes (hereinafter abbreviated as SPM) and are attracting particular attention.

A scanning atomic force microscope (hereinafter abbreviated as AFM) is an apparatus that detects an atomic force generated when a sample and a probe come close to each other and examines a surface state of the sample. In a scanning atomic force microscope of the related art, in general, the surface energy of a probe thereof is high, and thus in a case in which a very small amount of soft matter such as oils and fats is adhered to a surface of an object, the adhered soft matter will be adhered to the probe, and the probe may drag the adhered soft matter. This is a problem because it can be an obstacle in measuring a surface shape of an object.

In response to such a problem, in Patent Literature 1, a probe that suppresses the adhesion of the soft matter in such a manner that a contact angle with water is increased and thus an interaction (an attractive force) caused by the surface tension of adsorbed water between the sample and the probe is reduced is disclosed. Further, in Patent Literature 2, a probe in which the surface energy of a tip end portion of the probe is set to be lower than the interface energy between the tip end portion thereof and a substance to be measured to suppress the adhesion of soft matter is disclosed.

### CITATION LIST

### Patent Literature

[Patent Literature 1]

Japanese Unexamined Patent Application, First Publication No. S6-264217
[Patent Literature 2]

Japanese Unexamined Patent Application, First Publication No. 2000-155084

### SUMMARY OF INVENTION

### Technical Problem

According to the methods of the related art as disclosed in Patent Literature 1 and 2, the probe is obtained in such a manner that at least the tip end portion thereof is immersed in a solution of a fluorine-based coating material containing a fluoroalkyl group in advance and then heated to form a fluorine-based coating film. Although it is possible to form a coating layer by the methods, the formed coating layer is very fragile and it is difficult to repeatedly perform measurement with it, and thus reproducibility may not be obtained.

The present invention has been made in view of the above circumstances, and an object of the present invention is to provide a method of producing a probe which has excellent durability and can be repeatedly used for measuring a surface of a sample and a method of observing a surface of a sample using the probe.

### Solution to Problem

The present inventor has conducted extensive research to solve the above problems. As a result, they have found that it is preferable to provide an ultra-thin coating layer on the probe by a gas phase method and have conceived the present invention. That is, the present invention relates to the following matters.

(1) According to an aspect of the present invention, a method of producing a probe having a coating layer on a surface thereof is provided, including: forming the coating layer on a surface of a base material having a sharp tip end portion using a gas phase method.
(2) In the method of producing a probe according to (1), a high-frequency plasma treatment method is preferably used as the gas phase method.
(3) In the method of producing a probe according to (2), in the high-frequency plasma treatment method, a gas containing at least one type of fluorocarbon is preferably used as a raw material gas.
(4) In the method of producing a probe according to any one of (1) to (3), a thickness of the coating layer is preferably 100 Å or less.
(5) Preferably, the method of producing a probe according to any one of (1) to (4) further includes: a pretreatment step of pretreating the surface of the base material before performing the gas phase method, wherein the pretreatment step includes performing any treatment selected from the group consisting of a sputtering treatment, a corona treatment, a UV ozone irradiation treatment, and an oxygen plasma treatment.
(6) In the method of producing a probe according to (2), the high-frequency plasma method is preferably performed in a plasma generator, and a temperature inside the plasma generator is preferably 20° C. or higher and 80° C. or lower.
(7) In the method of producing a probe according to any one of (1) to (6), a shape of the base material is preferably a conical shape.
(8) In the method of producing a probe according to any one of (1) to (7), a thickness of the coating layer is preferably 0.1 nm or more.
(9) According to another aspect of the present invention, a surface observation method is provided, wherein the probe produced by the probe production method according to any one of (1) to (8) is used as a probe of a scanning probe microscope.
(10) According to still another aspect of the present invention, a surface observation method is provided, wherein a force due to a proximity interaction between the probe produced by the probe production method according to any one of (1) to (8) and a sample is measured using a scanning probe microscope including the probe.
(11) In the surface observation method according to (10), the force due to the proximity interaction is preferably an atomic force.
(12) In the surface observation method according to any one of (9) to (11), a surface of a magnetic recording medium may be observed using the probe.

### Advantageous Effects of Invention

According to the method of producing a probe of the present invention, it is possible to obtain a probe having excellent durability by forming a coating layer on a surface of the probe using a gas phase method. Therefore, it is possible to repeatedly observe a surface of a sample and obtain reproducible results using a scanning probe microscope including this probe.

### BRIEF DESCRIPTION OF DRAWINGS

FIG. 1 is a cross-sectional view of a probe obtained by a method of producing a probe according to an embodiment of the present invention and a cantilever including the probe.

FIG. 2 is a cross-sectional view of another example of a probe obtained by a method of producing a probe according to an embodiment of the present invention and a cantilever including the probe.

### DESCRIPTION OF EMBODIMENTS

Hereinafter, preferred examples of the present invention will be described in detail with reference to the drawings as appropriate. The drawings used in the following description may be shown with featured portions enlarged for convenience to make the features of the present invention easy to understand, and dimensional ratios or the like of constituent elements may differ from those of the actual constituent elements. Materials, dimensions, and the like exemplified in the following description are examples, and the present invention is not limited thereto and can be appropriately modified and carried out within the range in which the effects of the present invention are exhibited.

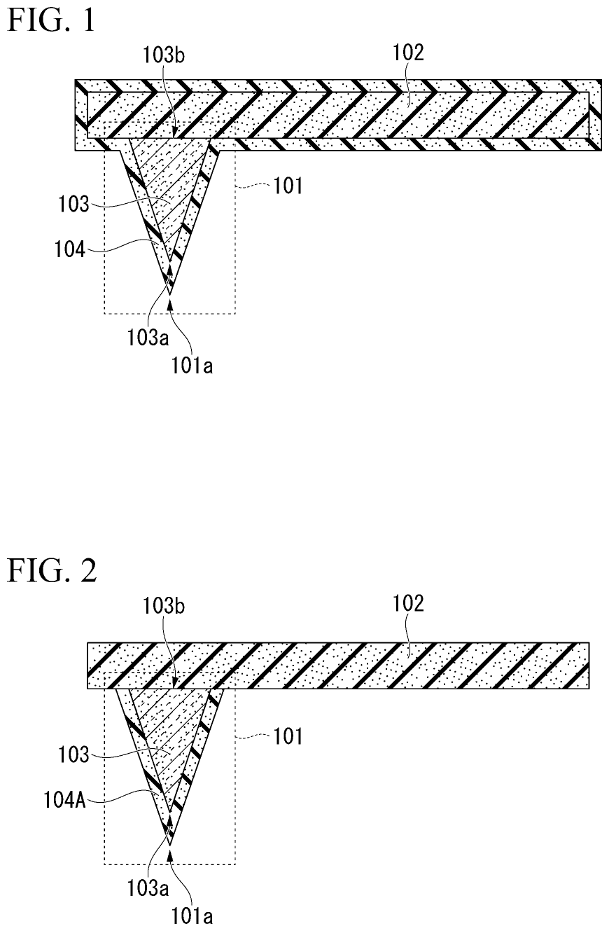

FIG. 1 is a cross-sectional view of a probe 101 obtained by a method of producing a probe according to an embodiment of the present invention and a cantilever 102 including the probe 101.

The probe 101 is constituted by a needle-shaped (cone-shaped) base material 103 having a sharp tip end portion 103a and a coating layer (a coating film) 104 that covers a surface other than a rear end portion 103b thereof. The base material 103 is attached such that the rear end portion 103b side thereof is in contact with one end side of the cantilever 102. The tip end portion 103a is a tip end of the base material 103. That is, the tip end portion 103a is a member of the base material 103 at a position remote from the cantilever 102. The rear end portion 103b is one surface of the base material 103. The rear end portion 103b is in contact with the cantilever 102. The rear end portion 103b may be formed independently of the cantilever 102, or may be integrated with the cantilever 102.

As for the shape of the base material 103, at least the tip end portion 103a only has to be sharp, and it is preferably conical. Here, the tip end portion 103a is a portion of about the same length as the maximum surface roughness of a surface of a substance to be measured from the tip end of the base material. That is, the length of the tip end portion 103a is about the same as the maximum surface roughness of the surface of the substance to be measured. For example, if the maximum surface roughness of the substance to be measured is 20 nm, a portion of 20 nm from the tip end corresponds to the tip end portion 103a.

A material constituting the base material 103 is not particularly limited, and for example, single crystal silicon, silicon nitride, and the like can be used.

The coating layer 104 is formed by a high-frequency plasma treatment method (a gas phase method) which will be described later and has a uniform film structure as compared with a case in which the coating layer is formed by a liquid phase method.

It is sufficient for the coating layer 104 to cover at least the surface of the base material 103 (an exposed surface in a state in which the base material 103 is attached to the cantilever 102), but it is also sufficient for the coating layer 104 to further cover a surface of the cantilever 102. FIG. 1 shows a configuration in which the coating layer 104 covers the surface of the base material 103 and the surface of the cantilever 102. In this case, if there is a boundary in the coating layer 104, the boundary tends to be a place where peeling is likely to occur, and thus a portion covering the base material 103 and a portion covering the cantilever 102 are preferably formed continuously.

From the viewpoint of increasing durability of the coating layer 104, the thickness of the coating layer 104 is preferably 0.1 nm or more and more preferably 0.2 nm or more. Further, from the viewpoint of maintaining sensitivity of the probe as a probe terminal, the thickness of the coating layer 104 is preferably 10 nm (100 Å) or less, more preferably 2 nm or less, and still more preferably 1 nm or less.

As a material of the coating layer 104, for example, a material containing at least one of fluorocarbons such as C₃F₈, C₄F₁₀, CHF₃, CF₄, and C₄F₈ is preferable.

In a case in which the substance to be measured adheres to the tip end portion 103a, the interface energy between the tip end portion 103a and the substance to be measured is about 50 dyn/cm. Since the probe 101 of the present embodiment has the coating layer 104 formed using a gas phase method, the surface energy of the tip end portion 101a is suppressed to 40 dyn/cm or less, and thus the interface energy with the substance to be measured becomes smaller. The tip end portion 101a is a tip end of the probe 101 having the coating layer 104.

Therefore, the probe 101 is more energetically stable when the surface of the probe 101 is exposed than when an interface with the substance to be measured is formed, and thus the substance to be measured does not adhere to the probe 101.

Even in a case in which the surface energy of the tip end portion 101a of the probe 101 is about the same as the interface energy with the substance to be measured, the surface energy of the substance to be measured is increased by the amount that the adhered substance to be measured is deformed and a surface area of the substance to be measured is increased, and thus adhesion does not occur.

The surface energy of the tip end portion 101a of the probe 101 is the surface tension of a droplet, which is derived from a relationship between the surface tension of a droplet dropped on the probe 101 and a contact angle, when the contact angle is 0°. This surface tension is actually inferred from the surface tension of a droplet when the droplet is dropped on a silicon wafer coated with the same material as that of the coating layer.

In the above example, although the configuration in which the coating layer 104 covers the base material 103 and the cantilever 102 is shown, the present embodiment is not limited to this example. As shown in FIG. 2, it may be a configuration in which a coating layer 104A covers only the base material 103.

### (Method of Producing Probe)

A method of producing a probe according to the present embodiment will be described.

First, the base material 103 for the probe is disposed between two electrodes installed in a treatment chamber constituting a plasma generator. In a case in which the coating layer 104 is formed only on the surface of the base material 103, the base material 103 is disposed in a state in which the base material 103 is placed on a support member. Further, in a case in which the coating layer 104 is also formed on the surface of the cantilever 102, the base material 103 is disposed in a state in which the base material 103 is attached to the cantilever 102. To form the coating layer 104 with a uniform thickness, it is preferable to dispose the tip end portion 103a of the base material toward an upstream side of the plasma.

Next, an organic gas consisting of at least one of fluorocarbons such as C₃F₈, C₄F₁₀, CHF₃, CF₄, and C₄F₈ is introduced into the plasma generator as a raw material gas, and the pressure therein is adjusted to 3 Pa or more and 15 Pa or less. Preferably, the pressure in the plasma generator is adjusted after the gas is introduced rather than at an initial stage (before the gas is introduced). Further, the temperature inside the plasma generator is preferably controlled in the range of 20° C. or higher and 80° C. or lower.

Next, a high-frequency voltage of 30 W or more and 300 W or less is applied between the two electrodes to generate plasma, and the surface of the base material 103 is irradiated with the plasma in the range of 1 second or more and 120 seconds or less, and thus the coating layer 104 having a thickness of 0.1 nm or more and 10 nm or less is formed.

Before the coating layer 104 is formed, that is, before plasma treatment is performed, the surface of the probe base material 103 may be subjected to pretreatments such as a sputtering treatment, a corona treatment, a UV ozone irradiation treatment, and an oxygen plasma treatment. By performing these pretreatments, the surface of the base material 103 is made smoother and cleaner, and the effect of forming the coating layer 104 formed thereon into a uniform film can be obtained.

### (Measurement Method Using Probe)

The probe obtained by the above-mentioned producing method can be applied to a scanning probe microscope. Specifically, it is possible to measure the shape and properties of the substance by bringing the tip end of the probe close to the surface of the substance to be measured and scanning while detecting a proximity interaction between the probe and the substance to be measured. Examples of the substance to be measured include a lubricating film made of a liquid lubricant formed on a magnetic film directly or via a protective film in a magnetic recording medium.

The probe 101 of the present embodiment is particularly effective in a case in which a force curve is measured. The force curve is a curve obtained by plotting a relationship between a distance between the probe and the substance to be measured and a force (deflection) acting on the cantilever to which the probe is attached. In a case in which the substance to be measured is a lubricating film constituting a magnetic recording medium (a magnetic disk), the force curve is obtained by plotting a relationship between a distance between the lubricating film and the probe and a force acting on the probe to separate the probe from the lubricating film. The maximum value of the force acting on the probe corresponds to an adsorption force of the probe with respect to the lubricating film.

An adsorption force of the probe 101 obtained by the present embodiment is about 1/10 times of an adsorption force of an untreated probe of which a surface is not coated. That is, according to the present embodiment, since the probe 101 has the coating layer 104, the adsorption force that hinders the measurement can be suppressed, and it is possible to avoid a problem in which a surface portion of the lubricating film is adsorbed to the probe at the time of measurement. Therefore, by applying the probe 101 according to the present embodiment to the scanning probe microscope, it is possible to improve the measurement accuracy of an atomic force generated between the surface of the lubricating film and the probe 101 and to measure the shape of the surface of the lubricating film accurately.

As described above, according to the method of producing a probe of the present embodiment, it is possible to obtain a probe 101 having excellent durability by forming a coating layer 104 on a surface of a probe using a gas phase method.

Therefore, it is possible to repeatedly observe a surface of a sample and obtain reproducible results using a scanning probe microscope including this probe.

### Example 1

Hereinafter, the effects of the present invention will be clarified with an example. The present invention is not limited to the following example and can be appropriately modified and implemented without changing the gist thereof.

### [Probe Production]

### Example 1

First, a single crystal silicon cantilever NCH-W (manufactured by Nano World AG) for a tapping mode (a mode in which a vibrated probe is periodically brought into contact with a sample surface) to which a base material for a probe is attached was installed in a treatment chamber of a plasma generator. Next, CHF₃ gas was introduced into the apparatus, the flow rate thereof was controlled, and the pressure thereof was set to 7 Pa. Next, in a plasma etching (PE) mode, the base material for a probe and the cantilever were subjected to plasma treatment at 30° C. for 10 seconds at an input power of 50 W. Through the above-mentioned steps, a probe having a coating layer formed by a gas phase method was obtained. Through XPS measurement, the thickness of the coating layer was found to be about 1 nm.

### Comparative Example 1

First, a solution for fluorine coating was prepared by diluting FLUORAD (registered trademark) FC722 manufactured by Sumitomo 3M Ltd. with FC726 (a fluorocarbon solvent) manufactured by Sumitomo 3M Ltd. 30 times. Next, a single crystal silicon cantilever NCH-W for a tapping mode to which a base material for a probe was attached was immersed in the solution for fluorine coating for 1 minute such that the entire base material was immersed. Next, the single crystal silicon cantilever NCH-W was heat-treated at 100° C. for 60 minutes.

Next, the heat-treated single crystal silicon cantilever NCH-W was immersed in FLUORINERT (registered trademark) FC3255 manufactured by Sumitomo 3M Ltd., which is a fluorine-based solvent, for 1 minute. Next, the single crystal silicon cantilever NCH-W was rinsed. Next, as the final heat treatment, a heat treatment at 150° C. for 60 minutes was performed. Through the above-mentioned steps, a probe having a coating layer formed by a liquid phase method was obtained. Through XPS measurement, the thickness of the coating layer was found to be about 1 nm.

### Comparative Example 2

A single crystal silicon cantilever NCH-W for a tapping mode to which a base material for a probe was attached was prepared. In Comparative Example 2, the coating layer as in Example 1 and Comparative Example 1 was not formed.

### [Measurement of Surface Energy of Probe]

As samples for surface energy measurement, a silicon wafer on which a coating layer was formed by a gas phase method as in Example 1, a silicon wafer on which a coating layer was formed by a liquid phase method as in Comparative Example 1, and a silicon wafer on which a coating layer was not formed as in the Comparative Example 2 were prepared.

The surface energy of each of the probes obtained in Example 1 and Comparative Examples 1 and 2 was obtained by using a so-called Zisman plot. That is, contact angles when various test droplets were dropped on a flat plate made of the same material as that of the probe were measured, and a graph of the surface tension of each of the test droplets and the contact angle thereof was created. In this graph, the surface tension when the contact angle was 0° was set as the surface energy of the probe.

The measurement results for the surface energy are shown in Table 1.

The surface energy of each of the probes of Example 1 and Comparative Example 1 which comprises a coating layer was suppressed to less than half of the surface energy of the probe of Comparative Example 2 which does not comprise a coating layer. Further, the surface energy of the probe of Example 1 in which the coating layer was formed by the gas phase method was further suppressed to be smaller than the surface energy of the probe of Comparative Example 1 in which the coating layer was formed by the liquid phase method.

### [Measurement of Surface Shape of Substance to be Measured]

A magnetic disk used as a substance to be measured was produced by the following procedure. First, a Ni—P plating film was formed on an aluminum alloy substrate. Next, a Cr base film, a Co—Cr—Ta alloy magnetic film, and a carbon protective film were formed on the Ni—P plating film in that order by sputtering. Then, these were immersed in and coated with a liquid lubricant of perfluoropolyether to form a lubricating film on the carbon protective film. As the liquid lubricant, Fomblin (registered trademark) Z-DOL having a concentration of 100 ppm was used. The immersion time in the liquid lubricant was set to 3 minutes, and the pulling-up time from the immersion time was set to 1 minute. The thickness of the formed lubricating film was determined from the infrared absorbance of a CF bond by a Fourier transform infrared spectrophotometer (FTIR) and found to be 1.0 nm.

The surface shape of the produced magnetic disk was measured by the AFM in each case in which the probes of Example 1 and Comparative Examples 1 and 2 were applied. As the AFM, D3000 manufactured by Digital Instrument Co., Ltd. was used, and measurements were performed three times in a tapping mode for each case. The measurement results for the surface shape are shown in Table 1.

TABLE 1

| | Measurement | | | |
|---|---|---|---|---|
| | of surface | Measurement of surface shape | | |
| | energy | First | Second | Third |
| Example 1 | 20 dyn/cm | A | A | A |
| Comparative | 25 dyn/cm | A | B | C |
| Example 1 | | | | |
| Comparative | >50 dyn/cm | C | C | C |
| Example 2 | | | | |

In a microphotograph of the surface of the magnetic disk on which the lubricating film was formed, when an image was clear, it was set as A, when the image was partially unclear, it was set as B, and in a case when the image was totally unclear, it was set as C.

In the case of Example 1, the image of the surface of the magnetic disk was clear in all of the first to third measurements. From this result, it was found that in a case in which the probe having the coating layer formed by the gas phase method was used, the surface observation of the sample could be performed accurately and repeatedly and a reproducible result could be obtained. That is, the probe of Example 1 had high durability.

In the case of Comparative Example 1, the image of the surface shape of the magnetic disk was clear in the first measurement. However, from the second measurement, only fine irregularities on the surface of the carbon protective film were barely visible, and the form of a lubricant film and surface pollutants could not be discerned. From this result, it was found that, in a case in which the probe having the coating layer formed by the liquid phase method was used, the surface observation of the sample could not be performed accurately and repeatedly and it was difficult to obtain a reproducible result.

As shown in Table 1, it was found that, in a case in which the probe of Example 1 was applied, the surface observation of the sample could be performed accurately and repeatedly and a reproducible result could be obtained as compared with the case in which the probe of Comparative Example 1 was applied. It is presumed that this result could be achieved because the probe of Example 1 was formed by the gas phase method.

On the other hand, in a case in which the probe of Comparative Example 1 was applied, reproducibility was not confirmed. First reason for this is presumed to be that the solvent evaporates during the production process by the liquid phase method, and thus the formed coating layer does not easily form a dense film. Second reason for this is presumed to be that the viscosity of a coating material decreases during heating, and the formed coating layer does not easily form a uniform film.

In the case of Comparative Example 2, the surface shape of the magnetic disk did not become clear in any of the first to third measurements. Specifically, in a case in which the probe of Comparative Example 2 was applied, only fine irregularities on the surface of the carbon protective film were barely visible, and the form of a lubricant and surface pollutants could not be discerned. From this result, it was found that, in a case in which the probe not having the coating layer was used, the surface observation of the sample could not be performed accurately and it was more difficult to obtain a reproducible result when the surface observation is repeated.

### REFERENCE SIGNS LIST

101 Probe
101a Tip end portion
102 Cantilever
103 Base material
103a Tip end portion
103b Rear end portion

1. A method of producing a probe having a coating layer on a surface thereof, comprising: forming the coating layer on a surface of a base material having a sharp tip end portion using a gas phase method.

2. The method of producing a probe according to claim 1, wherein a high-frequency plasma treatment method is used as the gas phase method.

3. The method of producing a probe according to claim 2, wherein, in the high-frequency plasma treatment method, a gas containing at least one type of fluorocarbon is used as a raw material gas.

4. The method of producing a probe according to claim 1, wherein a thickness of the coating layer is 100 Å or less.

5. The method of producing a probe according to claim 1, further comprising: a pretreatment step of pretreating the surface of the base material before performing the gas phase method, wherein the pretreatment step includes performing any treatment selected from the group consisting of a sputtering treatment, a corona treatment, a UV ozone irradiation treatment, and an oxygen plasma treatment.

6. The method of producing a probe according to claim 2, wherein the high-frequency plasma treatment method is performed in a plasma generator, and wherein a temperature inside the plasma generator is 20° C. or higher and 80° C. or lower.

7. The method of producing a probe according to claim 1, wherein a shape of the base material is a conical shape.

8. The method of producing a probe according to claim 1, wherein a thickness of the coating layer is 0.1 nm or more.

9. A surface observation method, wherein the probe produced by the probe production method according to claim 1 is used as a probe of a scanning probe microscope.

10. A surface observation method according to claim 9, wherein a force due to a proximity interaction between the probe and a sample is measured using theft scanning probe microscope including the probe.

11. The surface observation method according to claim 10, wherein the force due to the proximity interaction is an atomic force.

12. The surface observation method according to claim 9, wherein a surface of a magnetic recording medium is observed using the probe.
